(19) United States
(12) Patent Application Publication
(10) Pub. No.: US 2022/0086525 A1
(43) Pub. Date: Mar. 17, 2022

(54) EMBEDDED INDICATORS

(71) Applicant: Hewlett-Packard Development Company, L.P., Spring, TX (US)

(72) Inventors: Syed S. Azam, Spring, TX (US); Alexander Williams, Spring, TX (US); Louis R Jackson, Spring, TX (US)

(73) Assignee: Hewlett-Packard Development Company, L.P., Spring, TX (US)

(21) Appl. No.: 17/418,805

(22) PCT Filed: May 24, 2019
(86) PCT No.: PCT/US2019/033891

§ 371 Date: Jun. 26, 2021

(51) Int. Cl. H04N 21/442; H04N 21/435; H04N 21/45; G06K 9/00

(52) U.S. Cl. CPC H04N 21/44218; G06K 9/00315; H04N 21/4532; H04N 21/4355

(57) ABSTRACT

An example system including a processor and a memory. The memory resource may store machine-readable instructions to cause the processor to assign a subject state indicator to a pixel to depict a subject in a video frame of a video signal, wherein the subject state indicator is based on a psychophysiological state of the subject to be depicted by the pixel, embed the subject state indicator for the pixel in the video signal, and broadcast the video signal with the embedded subject state indicator for the pixel to a display device.

### BACKGROUND

With the incorporation of computing devices and displays into every facet of daily life, the access to, demand for, and consumption of various types of content has increased. For example, digital content such as video, audio, images, etc. is prevalent.

### BRIEF DESCRIPTION OF THE DRAWINGS

FIG. 1 illustrates an example of a system utilizing embedded indicators consistent with the present disclosure.

FIG. 2 illustrates an example of a non-transitory machine-readable memory and processor for utilizing embedded indicators consistent with the present disclosure.

FIG. 3 illustrates an example of a method for utilizing embedded indicators consistent with the present disclosure.

FIG. 4 illustrates an example of a video signal embedding device for utilizing embedded indicators consistent with the present disclosure.

### DETAILED DESCRIPTION

Capturing digital content may include utilizing sensors to digitize video, audio, images, etc. The digitized content may be broadcasted for display to a user. The information being broadcast may include an electronic representation of content in the form of encoded digital data. For example, views and/or audio of a real-world environment may be captured by a sensor such as a camera and/or microphone. The views may be encoded into a series of digital images to be displayed to a user in rapid succession. In the context of video, each of the images may be referred to as a frame.

Each of the frames may also be created anew by an artist, producer, content creator, graphics engine, etc. For example, a content creator may create the frame of a non-real-world environment as opposed to utilizing sensor data from the real-world environment. In addition, some frames may be created by a hybrid of sensor data and content creators' creations.

Each of the frames may be a bitmap representing a digital image or display. As such, each of the frames may include a digital description of a raster of pixels. A pixel may include or be defined by a property such as color, which may be represented by a fixed number of bits expressed in the digital data.

Users may wish to consume content that is more informative and/or immersive relative to other content, as examples. For example, users may wish to consume content that provides the user with a sense of being present in or fully engaged in the content. In some examples, content creators, capturers, broadcasters, etc. may attempt to make the content more immersive by increasing the quality of the display of the content. For example, luminance and/or high dynamic range (HDR) values for pixels of the frame may be embedded into a video signal to improve the appearance of the frames and provide a more realistic appearance of the frame on the display.

In other examples, such as radio delivered audio content, the primary content may include an audio signal or sound wave superimposed on a radio carrier wave. In some examples, creators, capturers, broadcasters, etc. may attempt to make the content more immersive by including information carried by the carrier wave that provides a user with additional information. For example, radio transmissions may include additional information such as time, station details, program and music information, scores, news, and traffic bulletins transmitted through the radio data system (RDS) communication protocol standard. The additional information may be formatted to be textually displayed on the display of a radio.

Users may feel psychologically and/or physically detached from the images on a screen or other content of a video feed, for example. This detachment may detract from their sense of being immersed in the content and/or their sense of enjoyment of the content. In some examples, unmodified displayed content may not be well suited to communicating psychophysiological information that may influence a user's experience when consuming the content.

Further, the additional information provided with content may not include enough information of the scope and/or type that a user desires or other information that could assist a user in becoming immersed in the content. For example, knowing how a subject of the content is feeling or how it might make them feel to watch the content may increase a user's sense of immersion.

In addition to more immersive content, a user may wish to consume tailored content. Tailored content may include content that is particularly suited to and/or modified to conform to a user's specific preferences and/or sensitivities. That is, tailored content may include content that is tailored in a manner that may increase the particular user's sense of immersion in or enjoyment of the content.

Content tailoring may rely on post-production processing of the content that is performed after the content is created and/or after the content is broadcasted. As such, post-production processing may utilize the processing resources of a user's display or a web server to tailor the content. Further, post-production processing to tailor content may utilize computational resources or human intervention to try to understand the content and what its intended message is. For example, post-production processing to tailor content may rely on human or machine guesses about the context, implications, or message of the content. Further, post-production processing of content may rely on guesses about the intent of the creator of the content with regard to the context, implications, or message that the content was intended to convey. For example, post-production processing to tailor content may be performed by a content consumer or an intermediate between the content consumer and the producer of the content. For example, content tailoring operations may rely on a computational resource and/or human making uninformed guesses about the context, implications, or messages of content after the content has been produced and/or distributed.

In contrast, examples consistent with the present disclosure may incorporate a subject state indicator into a content signal. The indicator may be utilized to provide a user a more immersive viewing experience and/or tailored content, such as by indicating a psychophysiological state of a subject of the content. The indicator may inform context, implications, or a message of the content. The indicator may be based on psychophysiological data captured from sensors in the environment where the content is captured and/or a designation of a content creator's original intent. The psychophysiological indicator may be utilized to further inform the user about the content and/or to tailor the content to the user.

For example, examples consistent with the present disclosure may include a system including a processor and a memory storing machine-readable instructions executable by the processor to perform a number of operations. The operations may include assigning a subject state indicator to a pixel to depict a subject in a video frame of a video signal, wherein the subject state indicator is based on a psychophysiological state of the subject to be depicted by the pixel; embedding the subject state indicator for the pixel into the video signal; and broadcasting the video signal with the embedded subject state indicator for the pixel to a display device.

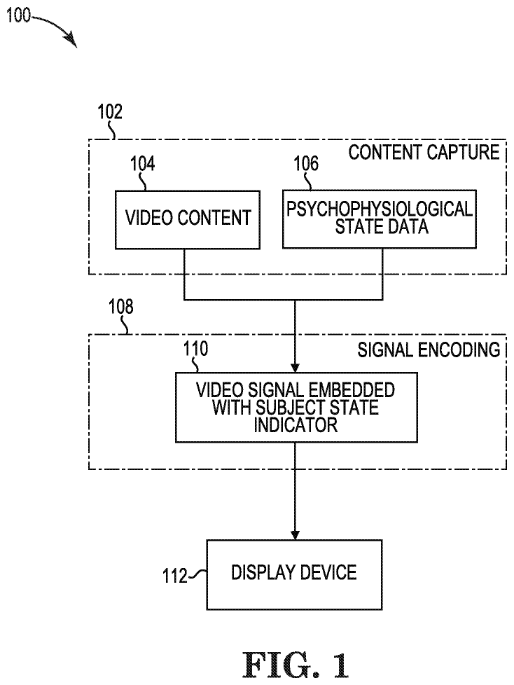

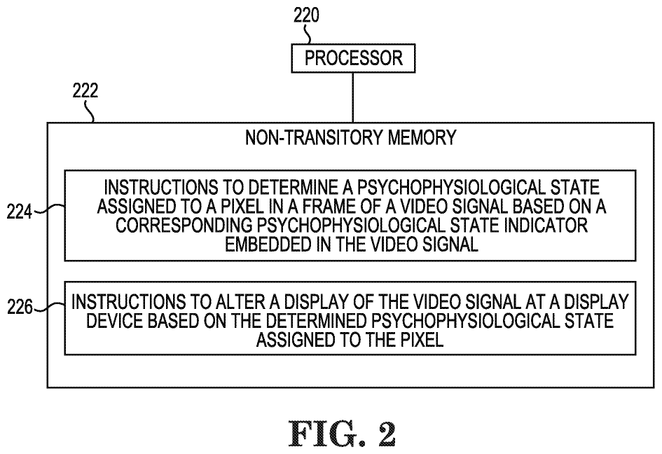

FIG. 1 illustrates an example of a system 100 utilizing embedded indicators consistent with the present disclosure. The described components and/or operations of system 100 may include and/or be interchanged with the described components and/or operations described in relation to FIGS. 2-4.

The system 100 may include a plurality of operations for creating content. Content may include media content such as entertainment content in the form of a video signal. The content may be captured, encoded, and prepared for broadcast as illustrated in system 100. In some examples, content may include a live stream of an electronic sport (Esports) event where competitors are live streamed competing in video game competitions. In some examples, the content may include interactive content such as video games. In some examples, the content may include entertainment programming such as televisions shows, series, movies, etc.

The system 100 may include a content capture operation 102. A content capture operation 102 may include capturing content to be displayed to a user. For example, a content capturing operation 102 may include capturing video content 104.

Capturing video content 104 may include capturing audio and/or visual representations of an environment utilizing a sensor, such as a video camera, microphone, etc. For example, a capturing video content 104 may include capturing video of a real-life environment, a live event, a theatrical event, a movie set, a television or movie production, etc. Capturing video content 104 may include capturing a video of subjects, such as objects, people, places, actors, animals, etc., to be displayed to a user. Capturing video content 104 may include electronically capturing a video as a series of images including electronic representations of the environment and/or subjects as distinct frames each segmented into a raster of pixels. Each pixel may include data encoded with information describing how the video content should be reproduced and/or visually represented in a corresponding area on a display.

Operations to capture the video content 104 may include capturing artificial images, artificial frames, artificial environments, artificial subjects, artificial pixels, and/or artificial data encoded with information describing how the video should be reproduced and/or visually represented in a corresponding area on a display. For example, capturing video content 104 may include generating video frames of artificial subjects, such as artificial objects, artificial people, artificial places, artificial actors, artificial animals, mystical beings, etc., to be displayed to a user. That is, rather than wholly consisting of images captured from real-world environments, the video capture 104 may include, at least in part, an artistic creation that is created by a producing entity. As used herein, a producing entity may include an artist, director, content creator, producer, graphics engine, actor, production company, etc. that is producing the video content.

For example, capturing video content 104 may include capturing images of animations or computer-generated graphics. Like the real-word video content 104, artificially produced video content 104 may be electronically captured as a plurality of frames, to be displayed in succession, each frame made up of a raster of pixels. Each pixel in a frame may include data encoded with information describing how the video content should be reproduced and/or visually represented in a corresponding area on a display.

The content capture operation 102 of system 100 may include the capturing of data in addition to the video content 104. That is, in addition to the video and/or audio data associated with video content 104, the content capture operation 102 of system 100 may capture psychophysiological state data 106. For example, the content capture operation 102 may include collecting psychophysiological state data 106 that corresponds to the video content 104.

Psychophysiological state data 106 may include data informing a psychological and/or physiological state or response of a subject. For example, Psychophysiological state data 106 may include data informing a psychological and/or physiological state or response of a person. Psychophysiological state data 106 may include data indicative of an emotional state, a mood, a feeling, a biological state, a mental state, a cognitive state, a state of mind, a response, etc. Psychophysiological state data 106 may include data such as vital signs. As used herein, vital signs may include body temperature, heart rate, pulse, respiratory rate, blood pressure, oxygen saturation, pain, blood glucose, carbon dioxide production and clearance, gait, brain activity, etc. Additionally, psychophysiological state data 106 may include data such as mannerisms, voice patterns, facial expressions, body mechanics, skin tone, skin coloration, language patterns, vocalizations, eye movement, etc. Further, psychophysiological state data 106 may include data such as direct indications or pronouncements of a psychophysiological state.

Capturing psychophysiological state data 106 may include collecting data that is indicative of a psychophysiological state associated with the images of the video capture 104. For example, capturing the psychophysiological state data 106 may include collecting data that is indicative of a psychophysiological state associated with the environment and/or subjects featured in the images of the video capture 104. For example, capturing psychophysiological state data 106 may include capturing assignments of psychophysiological state data 106 from a producing entity and/or utilizing sensors to capture psychophysiological state data 106 from subjects featured in the images of the video capture 104. For example, sensors may include cameras, temperature sensors, humidity sensors, heat mapping sensors, moisture sensors, pulse monitors, electrodes, electrocardiograms, electromyograph, blood glucose monitors, neuroimaging sensors, muscle activity sensors, brain imaging sensors, body movement sensors, eye gaze tracking sensors, etc. that collect the psychological and/or physiological reaction of a subject to stimuli.

Since a video frame of the video content 104 may include a plurality of subjects and/or environmental components, different portions of the frame (e.g., different pixels) may include different ones of subjects and/or environmental components. As such, capturing the psychological state data 106 may include collecting data that is indicative of an independent psychophysiological state of each subject, environmental component, and/or portion of the video frame of the video content 104. That is, a psychophysiological state of each subject, environmental component, and/or portion of the video frame of the video content 104 may be collected independently.

In some examples, capturing the psychophysiological state data 106 corresponding to the video content 104 may include collecting data that is indicative of a psychophysiological state that is intended to be communicated by or through the video content 104. For example, capturing the psychophysiological state data 106 corresponding to the video content 104 may include collecting data that is indicative of a psychophysiological state that is intended to be communicated, by the producing entity responsible for the video capture 104 that produced the content. Example of a producing entity includes an artist, a director, a content creator, a producer, a graphics engine, and the like. That is, the psychophysiological state data 106 data may include data that is indicative of the intent of the content creator regarding the intended psychophysiological state associated with each subject and/or environmental component featured in the captured images of the video content 104. In some examples, capturing the psychophysiological state data 106 corresponding to the video content 104 may include collecting data that is indicative of a psychophysiological state that is intended, by the producing entity, to be conveyed as experienced by each subject and/or environmental component featured in the video content 104. In some examples, capturing the psychophysiological state data 106 may include collecting data that is indicative of a psychophysiological state that is intended, by the producing entity, to be elicited in a user upon viewing each subject and/or environmental component featured in the captured images of the video content 104.

In some examples, the psychophysiological state data may be input, designated, and/or assigned to each portion of the environment and/or each subject featured in the environment by a content creator. For example, rather than being captured directly from the environment and/or each subject featured in the environment, as described in further detail below, the producing entity responsible for the video content 104 may enter, input, designate, or otherwise assign a corresponding psychophysiological state data intended to be conveyed by, elicited by, experienced by, and/or associated with each environmental component and/or each subject featured in the images of the video content 104. For example, capturing the psychophysiological state data 106 corresponding to the video content 104 may include capturing a content creator's psychophysiological grading of each frame, each pixel, each subject, each environmental component, etc. of the video content 104. For example, a content creator may perform a psychophysiological grading by assigning a psychophysiological state and/or psychophysiological state value to each frame, each pixel, each subject, each environmental component, etc. of the video content 104. The grading may be based on the intent of the content creator.

Capturing the psychophysiological state data 106 may, additionally or alternatively, include capturing psychophysiological state data from the subjects appearing in the video content 104. That is, the psychophysiological state data 106 may be captured directly from the environment and/or each subject in the environment being captured in the images of the video content 104. The psychophysiological state data for each environmental component and/or each subject being captured in the video content 104 may be captured simultaneous with and/or during the capture of the images making up the video content 104.

In an example, the environment and/or each subject featured in the images of the video content 104 may be monitored during the process of the content capture operation 102. That is, the observable psychophysiological responses of each of the subjects may be measured throughout the content capture operation 102. As an example, a sensor or an array of sensors may collect psychophysiological state data from the environment and/or each subject featured in the video content 104 during the process of capturing the images of the video content 104.

For example, simultaneous with and/or synchronized to capturing the video content 104 with a camera, sensors may detect psychophysiological state data for each subject or group of subjects that will appear within a video frame of the video content 104. The psychophysiological state data, and/or other types of information, may be utilized to determine a psychophysiological state of environmental components and/or each subject within an environment being captured in images making up video content 104. For example, a psychophysiological state for each subject may be determined utilizing known neurobiological correlations between the psychophysiological state data measurement and various psychophysiological states.

The system 100 may include a signal encoding operation 108. The signal encoding operation 108 may include encoding the video content 104 and the psychophysiological state data 106 captured in the content capture operation 102 into a video signal 110. As such, the signal encoding operation 108 may include combining the video content 104 and the psychophysiological state data 106 to generate a video signal 110. The video signal 110 may include the captured video frames of video content 104 and indicators of the captured psychophysiological state data 106. Specifically, pixel-level indicators of the captured psychophysiological state data 106 may be embedded into the video signal 110.

As described above, each captured video frame of the video content 104 may include a plurality of pixels that, in combination, make up a displayable image of the video frame. For example, each frame of the video content 104 may include an image that is segmented into a raster of pixels and each pixel may include a unit of the image that contains instructions to reproduce that unit at a corresponding location of a display device.

Combining the captured video content 104 and the captured psychophysiological state data may to generate the video signal 110 may include assigning respective psychological state indicators to their corresponding subjects and/or pixel locations in the video frame. For example, a subject state indicator may be assigned to a pixel that will depict the subject in the video frame of the video signal 110 or a pixel in the video frame that is associated with the subject but does not depict the subject. The subject state indicator may be assigned to a portion or all of the pixels that will depict the corresponding subject and/or are associated with the subject but do not depict the subject. Where multiple subjects are present in the video frame, a respective subject state indicator may be assigned to each respective corresponding pixel, pixels that will depict the corresponding subject, or a representative pixel that is associated with the subject but does not depict the subject. In some examples, each of the plurality of pixels making up each video frame of the video signal 110 may have a corresponding subject state assigned. That is, each pixel of a particular video frame may be assigned a corresponding subject state indicator that indicates the psychophysiological state associated with the pixel as determined from the psychophysiological state of the subject depicted in the pixel. In other examples, selective pixels are assigned a corresponding subject state indicator.

A captured video frame of the video content 104 may include a subject such as a person. Psychophysiological state data 106 may be captured from that person during the capture of the video content 104. The psychophysiological state data 106 may be attributed to and/or associated with that person. That person may appear in a portion of the video frame (e.g., a portion of the pixels making up the frame) to be encoded into the video signal 110. As such, the person may be associated with a portion of the pixels making up the video frame. For example, the person may appear in and/or have their appearance described by data encoded within a portion of the pixels making up the video frame of the video signal 110. The other pixels in the video frame may be associated with or describe the appearance of other people and/or other environmental components.

As described above, the psychophysiological state data 106 may be captured from and/or attributed to each individual subject appearing in a video frame of the video content 104. For example, psychophysiological state data of a first subject may be collected indicating that the first subject is demonstrating an elevated breathing rate, elevated heart rate, blushing, increased muscle tension, piloerection, sweating, hyperglycemia, eyebrows that are raised and pulled together, raised upper eyelids, tensed lower eyelids, stretch lips, dilated pupils, etc. This psychophysiological state data may, in such examples, be indicative of a psychophysiological state such as fear being experienced by the first subject.

While an example of the fear psychophysiological state is stated above, examples are not so limited. For example, a psychophysiological state may include various physical, mental, and/or emotional states and/or combinations thereof and therebetween. In some examples, a psychophysiological state may include subcategories of various physical, mental, and/or emotional states and/or combinations thereof and therebetween. For example, the psychophysiological state may include a positive emotional state, a negative emotional state, a calm physical state, an excited physical state, etc. That is, while the range of psychophysiological states able to be experienced by a subject may be nuanced and numerous, the psychophysiological state data may be simplified into subcategories of psychophysiological states that may encompass a variety or distinct but related psychophysiological states. For example, a positive emotional state may include joy, pride, satisfaction, surprise, etc. A negative emotional state may include sadness, boredom, disgust, anxiety, etc. A calm physical state may include contentment, sadness, boredom, etc. An excited physical state may include anxiety, anger, fear, surprise, joy, etc.

Therefore, each of the pixels associated with that first subject may be assigned a subject state indicator determined from the psychophysiological state data captured for the first subject during the capture of the video content 104. The subject state indicator may include a value, such as a bit value to be embedded into the video signal 110. The subject state bit value may include a bit value in addition to any bits or bit values for the pixel describing a display characteristic, such as color, for the pixel. The subject state indicator may include a bit value that indicates a psychophysiological state of a subject to be depicted by the pixel to which it is assigned. In addition, the subject state indicator may also include an electronic encoding that communicates all or a portion of the psychophysiological state data 106 captured for the subject to be depicted by the pixel.

The subject state indicator for each pixel may be embedded in the video signal 110 along with the bit value or values for the pixel describing a display characteristic. For example, the video signal 110 may include pixel-level level data for creating a display of the video frame that is additionally embedded with pixel-level subject state indicators. The video signal 110 may, therefore, be embedded with the data describing how to generate a display of each of the pixels of a video frame of the video content 104 along with the subject state indicators for each of the pixels of the video frame of the video content 104.

Each subject to appear in the video frame may have and/or exhibit a distinct psychophysiological state. As such, the psychophysiological state data 106 collected during the content capture operation 102 may include distinct psychophysiological state data for each of the subjects. As such, each of the subjects may be associated with a distinct subject state indicator. The video content 104 may, in captured images of each of the subjects in the video frame, have distinct portions of pixels that depict a corresponding one of each of the subjects. Each of pixels of each of the distinct portions of pixels of the video frame may be assigned a distinct respective subject state indicator corresponding to and determined from the psychophysiological state captured for the corresponding subject depicted by the portion of pixels. That is, each pixel or portions of pixels corresponding to each subject within the video frame of video content 104 may be assigned a distinct subject state indicator that is embedded in the video signal 110 in the signal encoding operation 108.

Once the video content 104 and the psychophysiological state data 106 are combined, as described above, to generate the video signal 110 with the embedded pixel-level subject state indicator, the video signal 110 may be transmitted. For example, the video signal 110 with the embedded subject state indicator may be broadcasted to a display device 112 to be transformed into a displayed image based on the instructions (e.g., video signal bits, subject state indicator bits, etc.) encoded in the video signal 110.

In some examples, the video content 104 may be recorded, subjected to video editing, mixed, subjected to sound editing, reviewed, etc. prior to being transmitted. That is, the video content 104 may include highly-produced and edited content such as a television program or series that is produced well in advance of its broadcast.

In another example, the video content 104 may be captured, encoded, and/or transmitted substantially simultaneously. That is, the content capture operation 102 and the signal encoding 108 operation may occur substantially simultaneously. For example, the content may include an on-line live-streaming of video content 104. For example, the video content 104 may include live-streaming of a video game and/or a person playing a video game. In some examples, the video content 104 may include live-streaming of an Esports video game competition between a plurality of competing players. In such examples, the respective subject state indicators of each pixel of the live video stream may be determined based on the captured psychophysiological state data of a corresponding competing player to be depicted in each corresponding pixel and embedded in the video signal simultaneous with the capture of the video content 104. That is, the content capture operation 102 and the signal encoding 108 may occur immediately to package the content for immediate transmission to a display device 112.

As described above, the video signal 110 generated from the content capture operation 102 may be broadcasted to a display device 112 to be utilized to generate a display of a video frame of the video signal 110 at the display device 112 based on the instructions encoded in the video signal 110. However, the display device 112 may alter the video signal 110. For example, the display device 112 may alter the appearance of a video frame of video content 104 encoded in the video signal 110. For example, the display device 112 may generate and/or display an altered video frame which may include a video frame that has a modified appearance relative to the original frame captured in the capture of the video content 104, the original frame encoded in the video signal 110, and/or the original frame broadcast in the video signal 110. The alterations to the video frame may be performed at the pixel level and/or based on subject state indicators that are associated to the video frame with pixel-level specificity. That is, the video frame may be altered on a pixel-by-pixel level. For example, a particular pixel or pixels of the video frame may be selectively altered.

In some examples, the alteration of the video signal 110 may be performed after transmission, such as at the display device 112 where the video signal 110 is to be displayed. In some examples, the display device 112 where the altered video frame is to be displayed may also perform the modification to the frame of video content 104 encoded in the video signal 110 to create the altered video frame. In other examples, a distinct computing device may perform the modification and transmit the altered video frame to the display device 112 to be displayed.

In examples, the system 100 may include altering a display of a video frame of the video content 104 encoded in the video signal 110. That is, the appearance of the video frame when displayed on a display device 112 may be altered such that the video frame has a modified appearance relative to the captured video frame of the video content 104 encoded in the video signal 110. As described above, in addition to or instead of captured images of a real-world subject or event, a captured video frame may include a video frame that is artificially generated. For example, the captured video frame may include an artificially generated video frame including artificial images, artificial frames, artificial environments, artificial subjects, artificial pixels, and/or artificial data. For example, a captured video frame may include a computer-generated graphic. For example, capturing video content 104 may include generating video frames of artificial subjects to be displayed to a user.

A displayed image may be rendered from a video signal 110. The rendering of the displayed image may be altered from the image encoded in the video signal 110 by modifying a portion of a plurality of pixels making up a video frame of the video signal 110. For example, a display device or other computing device may alter how a portion of the plurality of pixels of the video frame of the video signal 110 will be displayed by the display device 112 relative to the originally captured and/or broadcasted video frame of video content 104.

As described above, each pixel may be assigned a subject state indicator. Additionally, the subject state indicator may be assigned to and/or be based on consideration of sub-pixels of a video frame and/or sub-pixel resolution rendering of subject. As described above, the subject state indicator of a pixel may be based on psychophysiological state data 106 of a subject associated with that pixel. In some examples, each pixel and/or each portion of the plurality of pixels making up the video frame may be altered based on their corresponding respective assigned subject state indicator that is embedded in the video signal 110. For example, as described above, a subject state indicator assigned to each pixel of a video frame may be embedded in the video signal 110 as a subject state indicator bit value. The subject state indicator bit value may include additional bits having value encodings interpretable as specific psychophysiological states as well as percentages of psychophysiological states of a corresponding subject.

The bit value for a given pixel or portion of pixels may be referenced, for example, by the receiving display device 112, against a lookup table providing a map of corresponding psychophysiological states for each subject state indicator values. As such, the display of a portion of the plurality of pixels at the display device may be altered based on a subject state indicator and/or a psychophysiological state corresponding to a subject corresponding to the portion of the plurality of pixels. For example, an embedded subject state indicator for the pixel may indicate, to the display device 112, which pixels among the plurality of pixels making up the video frame, are to be altered by a psychophysiological state-based video signal 110 alteration operation.

Therefore, the display device 112 may generate an altered video frames from the video signal 110 that is altered at the per-pixel level based on the subject state indicator that is derived from the psychophysiological state of a respective subject corresponding to each pixel. By altering the video frames of the video signal based on the psychophysiological state-based subject state indicators, the display of the video content 104 may be enriched, made more immersive, and/or tailored to a viewer on a psychophysiological level, as examples. The perception of video content as entertaining and engaging by a viewer may involve, in large part, elements of psychological/physiological arousal, empathy, etc. in the user. As such, enriching the content by altering the display of video frames according to the psychophysiological state-based subject state indicators associated with elements of the video content 104 may enhance perception of video content 104 as entertaining and engaging, for example.

Altering a video signal 110 based on the psychophysiological state-based subject state indicator associated with a subject of the video content 104 may include altering a video frame of the video signal 110 in a manner that enhances and/or complements the perception of the video frame by a viewer. For example, the rendering of a portion of the plurality of pixels of a video frame corresponding to a subject may be altered based on a subject state indicator assigned to the subject. The alteration may be an alteration that clarifies, intensifies, makes explicit, highlights, emphasizes, etc. the subject state indicator assigned to the subject.

For example, altering the video signal 110 may include causing a portion of the plurality of pixels that will depict a subject and/or that are associated with a subject to enhance the perception of the viewer by displaying data indicative of the psychophysiological state of the subject. For example, altering the video signal 110 may include causing a portion of the plurality of pixels that will depict a subject and/or that are associated with a subject to display a portion of the subject state indicator and/or a portion of the psychophysiological state data 106, captured in the content capture operation 102. That is, a portion of the subject state indicator and/or a portion of the psychophysiological state data 106 that is assigned to the pixels and/or assigned to a subject associated with a plurality of pixels may be displayed to a viewer in a manner that enhances the viewers perception of the video frame. For example, altering the video signal 110 may include altering a portion of the plurality of pixels based on their assigned psychophysiological state-based subject state indicator by causing the portion of the plurality of pixels to display a label or symbol communicating the assigned subject state indicator and/or a portion of the psychophysiological data 106 underlying the subject state assigned to the plurality of pixels and/or assigned to a subject associated with a plurality of pixels. For example, a subject such as a competitor in an Esports competition may be depicted by a plurality of pixels in a video frame of a video signal 110. A portion of the plurality of pixels depicting the competitor and/or pixels that do not depict the competitor but are otherwise associated with the competitor (e.g., pixels displaying competitor vital signs) may be altered from their original state to display psychophysiological data 106 of the competitor such as the competitors heart rate. The psychophysiological data 106 of the competitor utilized to alter the rendering of the video frame may be a portion of the psychophysiological data 106 embedded in the video signal 110.

Altering the video signal 110 may include altering a portion of the plurality of pixels based on their assigned psychophysiological state-based subject state indicator by causing the portion of the plurality of pixels to be modified in a manner that modifies a display characteristic, such as color (e.g., red for anger, blue for sadness, etc.), brightness (e.g., bright for happy, dim for sad, etc.), contrast, luminance, display position, resolution (e.g., lower resolution for tired, sick, or dying, etc.), etc., to communicate the assigned subject state indicator and/or a portion of the psychophysiological data 106 underlying the subject state indicator assigned to a subject associated with a plurality of pixels. For example, a subject such as a competitor in an Esports competition may be depicted by a plurality of pixels in a video frame of a video signal 110. A portion of the plurality of pixels depicting the competitor and/or pixels that do not depict the competitor but are otherwise associated with the competitor (e.g., pixels displaying competitor vital signs) may be altered by having their color shifted to a red hue from their original state to indicate the competitor is angry. In other examples, an icon or other graphic may be displayed in a specified area (e.g., group of pixels) to designate the subject state corresponding to the subject state indicator and/or the psychophysiological data 106. In an example, an emoticon may be displayed to designate the subject state corresponding to the subject state indicator and/or the psychophysiological data 106.

As described above, in some examples, the altered portion of the plurality of pixels may include the pixels where a subject is to be displayed. That is, the alteration may be to the same pixels that are displaying a subject from which the psychophysiological data 106 was collected. For example, the pixels displaying a person may be altered based on the subject state indicator. The subject state indicator may be based on the psychophysiological data 106 collected for the person during the content capture operation 102. However, in some examples, the altered portion of the plurality of pixels may include pixels outside of the pixels where a subject is to be displayed. That is, the alteration may be to different pixels form the pixels that are displaying a subject from which the psychophysiological state data 106 was collected. For example, the pixels located immediately below the pixels displaying a person may be altered based on the subject state indicator. The subject state indicator may be based on the psychophysiological data 106 collected for the person during the content capture operation 102.

Altering the video signal 110 may include altering a portion of the plurality of pixels based on their assigned psychophysiological state-based subject state indicator by causing the portion of the plurality of pixels to be modified in a manner that enhances and/or complements a psychophysiological state being exhibited, experienced, and/or communicated by the subject depicted in or otherwise associated with a plurality of pixels. Altering a portion of the plurality of pixels may include changing attributes of a pixel such as by changing the pixel to cause the display of a different color, brightness, contrast, luminance, display position, etc. from the attribute originally specified by the pixel. For example, altering a portion of the plurality of pixels may include causing, based on an assigned psychophysiological state-based subject state indicator, the portion of the plurality of pixels to be modified in a manner that modifies a display characteristic, such as color, brightness, contrast, luminance, display position, resolution, etc., to enhance or complement a psychophysiological state intended to be elicited from a viewer viewing the video frame with the subject associated with a plurality of pixels. For example, altering a portion of the plurality of pixels may include causing the portion of the plurality of pixels to be modified in a manner that highlights or otherwise emphasizes the portion of the display rendering pixels assigned a particular psychophysiological state-based subject state indicator.

Altering the video signal 110 may include altering a portion of the plurality of pixels based on their assigned psychophysiological state-based subject state indicator by causing the portion of the plurality of pixels to be modified in a manner that modifies a display characteristic, such as color, brightness, contrast, display position, resolution, etc., to cancel out, soften, counteract, or/or portray an opposite psychophysiological state to the psychophysiological state intended to be exhibited, experienced, and/or communicated by the viewing the video frame with the subject associated with a plurality of pixels. Altering a portion of the plurality of pixels based on an assigned psychophysiological state-based subject state indicator may include causing the portion of the plurality of pixels to be modified in a manner that modifies a display characteristic, such as color, brightness, contrast, display position, resolution, etc., to cancel out, soften, or/or elicit an opposite psychophysiological state from the viewer than the psychophysiological state originally intended (e.g., as communicated by the subject state indicator value embedded in the video signal 110) to be elicited from a viewer viewing the video frame with the subject associated with a plurality of pixels.

Altering the video signal 110 may include altering a portion of the plurality of pixels based on their assigned psychophysiological state-based subject state indicator by causing the portion of the plurality of pixels to be modified in a manner that displays a content warning prior to displaying the pixels of the video frame associated with the subject state indicator value. That is, the embedding of the psychophysiological state-based subject state indicator value within the video signal 110 may allow a display device 112 to understand the psychophysiological impact of and/or psychophysiological state communicated by a pixel prior to generating the corresponding image of the pixel on the display.

As such, the display device 112 may alter pixels of a first video frame of the video signal 110 that is to be displayed prior to a second video frame of the video signal 110, based on the second video frame having pixels with a particular assigned psychophysiological state-based subject state indicator. For example, the display device 112 may later the pixels of the first video frame to include an indication or warning that the subsequent second video frame will depict content having the particular determined psychophysiological state-based subject state indicator value assigned and/or be associated with a particular psychophysiological state. For example, a first video frame of video signal 110 may depict a person obliviously walking in the forest and a second frame of the video signal 110 may depict a monster jumping out from behind a tree and eating the person. The pixels of the first frame depicting the person may be embedded with subject state indicators that indicate the person in the first frame has or is associated with a happy psychophysiological state and, as such, the pixels are associated with a happy psychophysiological state. However, the pixels of the second frame depicting the monster may be embedded with subject state indicators that indicate the monster in the frame has or is associated with a violent, scary, and/or angry psychophysiological state. As such, altering a portion of the plurality of pixels based on an assigned subject state indicator may include causing a portion of the plurality of pixels of the first frame to be modified to cause the display of a content warning communicating that a subsequent frame (e.g., the second frame) will be depicting content associated with a violent, scary, and/or angry psychophysiological state.

Altering the video signal 110 may include altering a portion of the plurality of pixels based on their assigned psychophysiological state-based subject state indicator by causing the portion of the plurality of pixels to be modified in a manner obscures display of the content within the pixels associated with a particular psychophysiological state. Again, referencing the example above, the pixels of the second frame depicting the monster may be embedded with subject state indicators that indicate the monster in the frame has or is associated with a violent, scary, and/or angry psychophysiological state. The pixels of the second frame embedded with subject state indicators indicating a violent, scary, and/or angry psychophysiological state may have their content visually obscured based on their association to a violent, scary, and/or angry psychophysiological state. Obscuring the pixels may include modifying the pixels to appear as blurred, blacked out, and/or blended with the surrounding pixels or background of the video frame. Obscuring the pixels may also include modifying a narrative flow, narrative continuum, and/or storyline progression of the video signal 110. For example, obscuring the pixels of a video frame may include substituting an alternate video frame for an originally designated video frame of the video signal 110. For example, a video signal 110 may include a branching or forming narrative structure where alternate storylines may be presented. In some examples, this may include selecting an alternate storyline or set of subsequent video frames that express an alternate story line. The alternate storyline or alternate set of subsequent video frames may avoid or reduce the display of video frames having pixels that are associated with a particular psychophysiological state. For example, an original storyline of video content may have a strong horror story-component. As such, rendering of the video frames of the original storyline may result in the rendering of a first amount of pixels embedded with subject state indicators indicating a violent, scary, and/or angry psychophysiological state. However, an alternative storyline for the video content may not include the strong horror story-component. As such, rendering of the video frames of the alternate storyline instead of the original storyline may result in the rendering of a second amount of pixels embedded with subject state indicators indicating a violent, scary, and/or angry psychophysiological state. The second amount of pixels embedded with subject state indicators indicating a violent, scary, and/or angry psychophysiological state may be zero and/or may be less than the first amount of pixels, of the original storyline, embedded with subject state indicators indicating a violent, scary, and/or angry psychophysiological state.

In addition, the system 100 may include altering an environmental characteristic of the environment of the display device 112. For example, an environmental characteristic of an environment where the display of the video signal 110 is viewed. The environmental characteristic may be altered based on the psychophysiological state-based subject state indicator values for a pixel of a video frame being shown on the display device 112.

An environmental characteristic may include a condition in the environment that may be experienced by a user viewing the display device 112. An environmental characteristic may include a condition in the environment that may have a psychophysiological effect on the user. The environmental characteristic may include a condition in the environment that is generally unrelated to the generation of the video frame on the display device 112. That is, an environmental characteristic may include a condition in the environment that is generally not associated with being controlled by a display device 112. Some examples of an environmental characteristic may include lighting, humidity, air flow, scent release, temperature, sound control, fan speed, alert settings, home assistant settings, appliance settings, etc.

An environment where the display device 112 is viewed may include a user's home. A user's home may include a plurality of computing devices and/or smart devices. For example, a user may have a plurality of network-connected internet-of-things computing devices located in their home. Some examples of such computing devices may include a smart thermostat, a smart lightbulb, a smart outlet, a smart light fixture, a smart home assistant, an audio system, a smart appliance, a smart accessory, a fragrance emitting device, a smart fan, etc. Such devices may be able to customize the environment of the user's home by modifying influencing the environmental conditions according to a user's preference.

Altering an environmental characteristic of the environment where the display device 112 is viewed may include adjusting a setting of an internet-of-things device in a user's home. The setting may be adjusted to change the environmental characteristics of the environment in which a user is viewing the video signal 110 on the display device 112.

For example, altering an environmental characteristic may include instructing a device to adjust an environmental characteristic to enhance the user's experience of and/or reaction to viewing the video signal 110 in the environment. For example, when a frame includes an image of a monster and the pixels of that frame that depict the monster are associated with a violent, scary, fear-inducing, and/or angry psychophysiological state, altering the environmental characteristic may include dimming the lighting in the room where the display device 112 is being viewed and/or turning up the volume of a surround sound system playing the audio that accompanies the video frames. These alterations may contribute to a sense of immersion in the content as the user's real-life environment is presenting conditions that may enhance the user's response to the psychophysiological state and/or elevate the fear experienced by the user in viewing the content.

Alternatively, altering the environmental characteristic may include instructing a device to adjust an environmental characteristic in a manner that counteracts the user's experience of or reaction to viewing the video frames in the environment. For example, when a frame includes an image of a monster and the pixels of that frame that depict the monster are associated with a violent, scary, fear-inducing, and/or angry psychological state, altering the environmental characteristic may include brightening the lighting in the room where the display device 112 is being viewed and/or turning down the volume of a surround sound system playing the audio that accompanies the video frames. These alterations may contribute to a psychophysiological disconnection from the content as the user's real-life environment is presenting conditions that counteract the user's response to the psychophysiological state and/or decrease the fear experienced by the user in viewing the content of the video frames.

The alteration to the portion of the plurality of pixels and/or the environmental characteristics based on an assigned psychophysiological state-based subject state indicator may itself be varied from user to user. That is, the specific type of alteration to the plurality of pixels and/or the environmental characteristics may be tailored to a specific user that will be viewing the content at the display device 112. As described above, a user may select and/or favor content that is tailored to their specific preferences and/or psychophysiological reactions. As such, each user may have distinct preferences for an alteration type to be applied to the portion of the plurality of pixels and/or the environment in response to the detection of each psychophysiological state-based subject state indicator assignment within the pixels of a video frame.

The above described utilization of a lookup table to interpret psychophysiological states from subject state indicators may provide a mechanism for variation among users, while also allowing for a standardization in grading and/or assigning the subject state indicators to the pixels in the first place. That is, the pixels containing a monster that are assigned a subject state indicator associated with a violent, scary, fear-inducing, and/or angry psychophysiological state may have the same subject state indicator values assigned regardless of the varied preferences of the end user. The lookup table may, however, be customized to reflect the user's preferences. That is, the lookup table may identify distinct and customized psychophysiological states and/or alterations to the portion of the plurality of pixels and/or the environmental characteristics for each psychophysiological state-based subject state indicator value to reflect the specific user's preferences or reactions to content with the subject state indicator value.

For example, the particular alteration to the portion of the plurality of pixels and/or the environmental characteristics may be determined based on a preference expressed by a display user regarding the display of content having particular psychophysiological states and/or particular subject state values indicated of particular psychophysiological states. For example, a display user may enter or otherwise express their preferences for content associated with various psychophysiological states (e.g., “I enjoy being scared,” “I dislike being scared,” “I prefer scary movies,” “I like sad movies,” “I dislike sad movies,” etc.). A display user may enter or otherwise express their preferences for specific alterations to content and/or their environment when content associated with various psychophysiological states is going to be displayed (e.g., “I want to be warned when a scary scene is about to be shown,” “I want the display and/or environment to be altered in order to intensify scary content,” “I want the display and/or environment to be altered in order to detract from scary content,” “I want scary content filtered or otherwise obstructed during viewing,” “I want psychophysiological data and/or psychophysiological for subjects being displayed to be added to the display,” etc.). A display user may enter or otherwise express reactions or conditions from which they suffer that may be germane to the particular alteration to be applied to the pixels and/or environment (e.g., “I suffer from a heart condition,” “my pulse should not be elevated,” “I suffer from depression,” “I am easily startled,” “I suffer from an anxiety disorder,” etc.). The preferences may be entered via a user questionnaire and the alterations specified in the lookup table may be modified accordingly. In an example, scary or exciting content may be filtered and/or presented along with anti-excitement countermeasure alterations to the portion of the plurality of pixels and/or the environmental characteristics to users with heart conditions and/or anxiety disorders. For another example, sad or depressing content may be filtered and/or presented along with anti-depression countermeasure alterations to the portion of the plurality of pixels and/or the environmental characteristics for users suffering from depression.

In some examples, the system 100 may include a component that may learn a user's preferences and/or reactions to content associated with various psychophysiological states by observing the psychophysiological response of the user to viewing content associated with the psychophysiological state. That is, psychophysiological state data, including the psychophysiological response, may be collected from the user as the user views content associated with the psychophysiological state. By monitoring, for example, the physiological response of the user and/or any changes they make to their environment in response to viewing content associated with a particular psychophysiological state, the system 100 may determine a preference of the user for particular alteration to the portion of the plurality of pixels and/or to the environmental characteristics to be made when pixels assigned that same psychophysiological state are to be displayed. For example, if the user demonstrates an increased perspiration rate, winces, has an increased pulse rate, turns on the lights, and turns down the thermostat, and/or leaves the room when content associated with a scary psychophysiological state is displayed, the system 100 may cause the display device 112 to display a content warning to the user and to brighten the lightening and turn down the thermostat when displaying pixels associated with a scary psychophysiological state in the future.

Likewise, the system 100 may utilize substantially real-time feedback of the psychophysiological response or state of a display user in order to determine an appropriate alteration to the portion of the plurality of pixels and/or the environmental characteristics. That is, psychophysiological state data may be collected from the user as the user views content associated with the psychophysiological state. By monitoring, for example, the psychophysiological response of the user and/or any changes they make to their environment while viewing or preparing to view the content of the plurality of pixels of the video stream 110, the system 100 may determine a present psychophysiological state (e.g., elevated heart rate, high blood pressure, worried expression, increased perspiration, increased body temperature, etc.) of the display user and may determine an appropriate alteration to the portion of the plurality of pixels and/or the environmental characteristics. An appropriate alteration may be selected based on the current psychophysiological state of a display user and/or an anticipated effect of viewing the pixels with their assigned subject state on the display users present psychophysiological state. For example, if the system 100 determined that the current psychophysiological state of the user suggests a stressed, anxious, fearful, and/or panic stricken psychological state, the system may determine that anti-excitement countermeasure alterations to the portion of the plurality of pixels and/or the environmental characteristics should be implemented along with the display of any pixels that may be associated with stress, anxiety, fear, and/or panic based on their subject state indicator.

In addition, the psychophysiological state data 106 may include a plurality of measurements or assignments of psychophysiological state data. The psychophysiological state data 106 may be captured and/or cataloged. A portion of the psychophysiological state data 106 may be embedded in the video signal 110. A user may select what of the psychophysiological state data 106 will be embedded in the video signal 110. That is, a user may choose not to receive some of the psychophysiological state data 106 and/or have it used it determining the subject state indicator value for a pixel. Additionally, the psychophysiological state data 106 may be cataloged by embedding in the video signal 110. A user may choose which of the psychophysiological state data 106 embedded in the video signal 110 to display and/or to utilize in determining an alteration to a pixel.

FIG. 2 illustrates and example of a non-transitory machine-readable memory 222 and processor 220 for utilizing embedded indicators consistent with the present disclosure. A memory resource, such as the non-transitory memory 222, may be used to store instructions (e.g., 224, 226, etc.) executed by the processor 220 to perform the operations as described herein. The operations are not limited to a particular example described herein and may include and/or be interchanged with the described components and/or operations described in relation to FIGS. 1 and 3-4.

The non-transitory memory 222 may store instructions 224 executable by the processor 220 to determine a psychophysiological state assigned to a pixel in a video frame of a video signal. For example, a video signal may include a plurality of frames to be displayed on a display device. Each of the plurality of frames may include an image made up of a raster of a plurality of pixels. When displayed in rapid succession, the frames may constitute a video.

The video signal may include a video such as a television program, a movie, or other pre-produced/edited video presentation. In such examples, a producing entity may assign a psychophysiological state to each of the plurality of pixels in the frame. For example, each pixel that will display a character, subject, object, piece of scenery, etc. in the video frame may have a psychophysiological state corresponding to the character, subject, object, piece of scenery, etc. assigned thereto. The psychophysiological state may be the psychophysiological state that is intended by the producing entity. That is, the psychophysiological state and/or an indicator thereof may make explicit what a subject appearing in the frame is intended to be portraying and/or eliciting in a viewer.

For example, the psychophysiological state and/or an indication thereof in pre-produced/edited video presentation may include a categorization of a psychophysiological response that the character, subject, object, piece of scenery, etc. is intended to be experiencing, a categorization of a psychophysiological response that the character, subject, object, piece of scenery, etc. is intended to be communicating, and/or a categorization of a psychophysiological response that the character, object, piece of scenery, etc. is intended to elicit in a user when being viewed. For example, the psychophysiological state may include a categorization of a psychological response and/or physiological response that the character, subject, object, piece of scenery, etc. is intended to be experiencing, a categorization of a psychological response and/or physiological response that the character, subject, object, piece of scenery, etc. is intended to be communicating, and/or a categorization of a psychological response and/or physiological response that the character, subject, object, piece of scenery, etc. is intended to elicit in a user when being viewed.

In addition, the video signal may include interactive video such as a video game or other interactive presentation. As with the pre-produced/edited video content described above, a producing entity may assign a psychophysiological state and/or an indicator thereof to each of the plurality of pixels in the frame. That is, the psychophysiological state and/or an indicator thereof may make explicit what a subject appearing in the frame is intended to be portraying and/or eliciting in a viewer.

In some interactive video presentations, such as video games, a graphics engine may produce each pixel in the frame. In some examples, the graphics engine may also assign a psychophysiological state and/or an indicator thereof to each subject and/or to a portion of the plurality of pixels in the frame depicting the subject. For example, each pixel that will display a character, subject, object, piece of scenery, etc. in the interactive video frame may have a psychophysiological state and/or an indicator thereof corresponding to the character, subject, object, piece of scenery, etc. assigned thereto. The psychophysiological state and/or an indicator thereof may be a reference to a psychophysiological state that is intended by the producing entity.

For example, the psychophysiological state and/or an indicator thereof in interactive video presentations may include a categorization of a psychophysiological response that the character, subject, object, piece of scenery, etc. is intended to be experiencing, a categorization of a psychophysiological response that the character, subject, object, piece of scenery, etc. is intended to be communicating, and/or a categorization of a psychophysiological response that the character, subject, object, piece of scenery, etc. is intended to elicit in a user when being viewed. For example, the psychophysiological state and/or an indicator thereof may include a categorization of a psychological response and/or physiological response that the character, subject, object, piece of scenery, etc. is intended to be experiencing, a categorization of a psychological response and/or physiological response that the character, subject, object, piece of scenery, etc. is intended to be communicating, and/or a categorization of a psychological response and/or physiological response that the character, subject, object, piece of scenery, etc. is intended to elicit in a user when being viewed. That is, the psychophysiological state and/or an indicator thereof may make explicit what a subject appearing in the frame is intended to be portraying.

Further, the video signal may include live action or live streaming video signal such as an Esports competition or other live streaming presentation. Such examples may not be heavily edited and/or artistically directed. Such examples may include video frames capturing raw real-world reactions to stimuli that are immediately broadcasted or broadcasted on a slight delay (e.g., a matter of seconds or minutes). As such, psychophysiological data such as biological feedback data demonstrating a psychophysiological reaction of a competitor in an Esports competition to the competition may be collected by sensors in real-time and/or simultaneous with the capture of video frames of the competition.

Sensors may include cameras, temperature sensors, humidity sensors, heat mapping sensors, moisture sensors, pulse monitors, electrocardiograms, blood glucose monitors, neuroimaging sensors, muscle activity sensors, brain imaging sensors, body movement sensors, eye and/or gaze tracking sensors, etc. that may observe and/or assess the psychological and/or physiological reaction of a subject to stimuli. The sensors may be present in the environment where the subject is being recorded for the video frame. In the Esports example, the sensors may be embedded in a display and/or in gaming peripherals being utilized by the Esports competitor during the Esports competition. That is, the sensors may be utilized to capture psychophysiological state data contemporaneously with the capture of the video frames to be reproduced at a display device. This may allow for substantially simultaneous and/or substantially real-time assignment of psychophysiological state data and/or psychophysiological state indicators to their corresponding pixels without interrupting or post-processing frames from a live video stream.

The psychophysiological state data and/or an indication thereof may be collected from these sensors and may be assigned to and/or utilized to determine the psychophysiological state indicator assigned to the pixels of the video frame that are associated with the subject whence they are collected. Pixels that are associated with a subject may include pixels that, when displayed, depict at least a portion of the subject. Alternatively, or additionally, pixels that are associated with a subject may include pixels that, when displayed, do not necessarily depict the subject, but are assigned to display additional data about the subject (e.g., health meter, vital sign display, banner label, heads up display, etc.). For example, in the Esports video example, the pixels of the video frame corresponding to a position on a display device where the specific competitor will be displayed may be assigned the psychophysiological state data and/or an indication thereof, the pixels of the video frame corresponding to a position on a display device where the specific competitor's avatar or game character will be displayed may be assigned the psychophysiological state data and/or an indication thereof, and/or the pixels of the video frame corresponding to a position on a display device where the specific competitor's psychophysiological state data is designated to appear may be assigned the psychophysiological state data and/or an indication thereof.

In some examples, more than one subject may appear in the same video frame. A first portion of the pixels may correspond to and/or depict a portion of the first subject and a second portion of pixels may correspond to and/or depict a portion of the second subject. The first portion of pixels may be assigned the psychophysiological state data of and/or the psychophysiological state indicator determined from the psychophysiological state data collected from the first subject. The second portion of pixels may be assigned the psychophysiological state data of and/or the psychophysiological state indicator determined from the psychophysiological state data collected from the second subject. The psychophysiological state data of and/or the psychophysiological state indicator determined from the psychophysiological state data collected from the first subject may be distinct and/or different from the psychophysiological state data of and/or the psychophysiological state indicator determined from the psychophysiological state data collected from the second subject. The distinct data of the first subject and the second subject may be assigned to their respective corresponding different pixels within the same video frame.

As such, psychophysiological state data and/or a psychophysiological state indicator may be captured, determined, and/or assigned to each pixel of a video frame as the video frame is captured. The psychophysiological state data and/or psychophysiological state indicator assigned to each pixel may be embedded in the video signal. That is, the psychophysiological state data and/or psychophysiological state indicator assigned to each pixel may be transmitted as bits of data within the video signal to a display device and/or an intermediate image processing device. As described, all or part of the psychophysiological state data may be captured in the video signal and cataloged. A user may decide which of the psychophysiological state data to display, which of the psychophysiological state data to receive, which of the psychophysiological state data to be utilized in determining a psychophysiological state indicator, which of the psychophysiological state data to be utilized in determining alterations, etc.

A video signal encoded with video frames and embedded psychophysiological state data and/or indications thereof may be received at a display device. The display device and/or an intermediate image processing device may determine the psychophysiological state assigned to a pixel and/or each pixel in the video frame of the video signal. The display device and/or the intermediate image processing device may determine a psychophysiological state of each pixel based on the corresponding psychophysiological state data and/or the corresponding psychophysiological state indicator assigned to each pixel. For example, the display device and/or the intermediate image processing device may reference the value of the psychophysiological state data and/or the psychophysiological state indicator assigned to each pixel, and embedded in the video stream, against a lookup table to determine a psychophysiological state of each pixel.

The non-transitory memory 222 may store instructions 226 executable by the processor 220 to alter a display of the video signal. Altering a display of the video signal may include altering how the content, or even which content, is displayed at a display device. The alteration to the display of the video signal may be based on the determined psychophysiological state of each pixel in the video frame and/or their corresponding depicted subjects. In some examples, the alteration may include a pixel-by-pixel level alteration. That is, the alterations may be applied to specific pixels within the video frame. In some examples, the alteration may include a video frame level alteration. That is, the alteration may be applied to entire video frames or across a plurality of video frames. In some examples, the alteration may include a video signal level alteration. That is, the alteration may be applied to the entire video signal and/or a different video signal may be requested and/or substituted for a present video signal.

The specific alteration to be applied to the display of the video signal may be determined based on the determined psychophysiological state assigned to the pixel. For example, specific psychophysiological states may be associated with specific alterations or alteration types. In some examples, the specific alterations or alteration types associated with the specific psychophysiological states may be adjusted to the preferences, responses, and/or psychophysiological state of a user that will view the video signal.

In some examples, the specific alterations or alteration types associated with a specific psychophysiological state may be determined by referencing a psychophysiological state and/or an indicator thereof assigned to a pixel against a lookup table. The lookup table may map alterations to corresponding psychophysiological state values. The corresponding alteration may then be applied to the video signal.

In some examples, the rendering of the video signal at a display may be altered by visually highlighting or emphasizing the content of particular pixels associated with a psychophysiological state. For example, the psychophysiological state may include fear and/or the psychophysiological responses consistent therewith. A user may have indicated they enjoy being scared. As such, the look up table may indicate that pixels assigned a psychophysiological state indicator value indicating that they are associated with a fear psychophysiological state should be visually highlighted. As such, the pixels corresponding thereto may be altered to be brightened, visually sharpened, and/or otherwise visually emphasized over other pixels.

In some examples, the rendering of the video signal at a display may be altered by visually obscuring the content of the pixel to be displayed. For example, a pixel may be determined to be associated with a psychophysiological state. For example, the psychophysiological state may include fear and/or the psychophysiological responses consistent therewith. A user may have a medical condition and/or a preference to not see content that is associated with the fear psychophysiological state (e.g., they are easily scared, have a heart condition, suffer from PTSD, etc.). As such, the user may have expressed a preference that content associated with the fear psychophysiological state is filtered such that they do not see it. As such, the look up table may indicate that pixels assigned a psychophysiological state indicator value indicating that they are associated with a fear psychophysiological state should be visually obscured. As such, the pixels corresponding thereto may be altered to be blurred, blocked out by a solid color, blended into a sampled surrounding region of background, etc.

In some examples, the rendering of the video signal at a display may be altered by altering or inserting a video frame prior to causing the content of the pixel of a video frame to be displayed. For example, a video signal may be altered to generate a content warning to be rendered at the display prior to causing the content of the pixel to be rendered at the display. For example, a pixel may be determined to be associated with a psychophysiological state. For example, the psychophysiological state may include sadness. A user may have a medical condition and/or a preference to not see content that is associated with the sadness psychophysiological state (e.g., user is sensitive to sad images, user suffers from depression, user suffers from suicidal ideations, etc.). As such, the user may have expressed a preference that content associated with the sad psychophysiological state is filtered such that they do not see it. As such, the look up table may indicate that a user should be warned that pixels assigned a psychophysiological state indicator value indicating that they are associated with a sad psychophysiological state will be displayed subsequently. As such, a warning that sad content is about to be displayed may be displayed prior to displaying the pixels associated with the sad psychophysiological state.

In some examples, the rendering of the video signal at a display may be altered by causing the psychophysiological state, the psychophysiological state indicator, and/or psychophysiological state data captured from a subject may be displayed in the same video frame as the pixel. For example, in the Esports context, an Esports competitor's psychophysiological response during the competition may be captured along with the video frame data and embedded in the video signal. A user viewing the video signal as a live video stream may wish to view the captured video frame data and/or a portion of the psychophysiological response of the competitor. As such, the video signal may be altered such that the psychophysiological state indicator, and/or a portion of the psychophysiological state data captured from the Esports competitor may be rendered on the display in the same video frame as the pixel showing the Esports competitor, the Esports competitor's avatar, and/or the Esports competitor's game character.

In some examples, the alteration may be applied to the video signal responsive to an indication by a user that the alteration is presently desired by the user. For example, a user watching an Esports competition may be watching the video signal and decide that they are interested in the psychophysiological state of a competitor appearing in the video signal. The user may select the Esports competitor and/or indicate a portion of the Esports competitor's psychophysiological state data should be displayed and/or how it should be displayed. As such, the psychophysiological state indicator, and/or psychophysiological state data captured from the Esports competitor may be displayed in the same video frame as the pixel showing the Esports competitor.

As described above, the video signal and/or each video frame of the video signal may include more than one subject. For example, more than one Esports competitor may appear in a same video frame during an Esports live stream. A user viewing the Esports competition may have interest in more than one of the Esports competitors appearing in the video frame. The user may interest in the psychophysiological state of a first competitor and a second competitor appearing in the video signal. The user may switch between the first and second Esports competitors selecting which of the competitors' psychophysiological state indicators, and/or psychophysiological state data is to be displayed in the same video frame as the pixels showing the Esports competitors. That is, for any given frame of the video signal, an alteration may be applied to display the psychophysiological state indicator and/or a portion of the psychophysiological state data captured from any individual Esports competitor of a plurality of Esports competitors to appear in the video frame. Additionally, a user may select to display the psychophysiological state indicator and/or a portion of the psychophysiological state data captured from more than one Esports competitor appearing in the video frame. That is the psychophysiological state indicator and/or psychophysiological state data captured from more than one Esports competitor may appear simultaneously on the display of the video frame, such as with an indicator indicating which Esports competitor they belong to. Alternatively, or additionally, the user may select to display a comparison between the psychophysiological state indicator and/or psychophysiological state indicator data captured from more than one Esports competitor.

Therefore, since the psychophysiological state indicator and/or psychophysiological state data may be embedded in the video signal, the information utilizable to alter the display of the video signal may always be present within the video signal. However, the alterations to the display of the video signal may not always be applied. That is, the raw video frames may be displayed in some instances and the altered video signal may be applied in other instances. As such, what is actually displayed to the user is highly customizable and/or modifiable to the user's preferences.

In addition to altering the video signal an environmental characteristic of the environment where the rendering of the video signal is generated and/or displayed may be altered. That is, generating the display on a display device viewable by a user, may include adapting the environment that the user is viewing the display in to the psychophysiological state assigned to the content.

The environment where the display device is located may include smart-home and/or smart-environment devices that may be network connected devices that may be utilized to control environmental characteristics of the environment. The environmental characteristics may include characteristics of the environment such as such as the lighting, humidity, air flow, smell, temperature, sounds, sound volumes, vibrations, orientation of the display, orientation of a user, natural lighting, views, etc.

In some examples, altering the environmental characteristics of the environment where the display is generated may include altering such environmental characteristics based on the determined psychophysiological state assigned a pixel appearing in the video frame. The alteration to the environmental characteristic may be a user-specific and/or user-tailored alteration to an environmental characteristic that will either enhance or counteract the appearance of, communication of, and/or psychophysiological experience elicited by the display of the pixel on the display device.

For example, if a subject appearing in the video frame is a monster, the pixels of the video frame that characterize the display of the monster may be assigned a scary psychophysiological state. As such, altering the environmental characteristics of the environment based on the determined psychophysiological state assigned to the pixel appearing in the video frame may include diming the lights in the room of the display and increasing the volume of a surround sound system to enhance the experience of viewing the content associated with the psychophysiological state.

Alternatively, altering the environmental characteristics of the environment based on the determined psychophysiological state assigned to the pixel appearing in the video frame may include brightening the lights in the room of the display and decreasing the volume of a surround sound system to counteract the experience of viewing the content associated with the psychophysiological state. That is, the environmental characteristics may be altered in a manner that manipulates a psychophysiological response (e.g., increases fight or flight response and/or stimulates fear in the user by enhancing scariness, decreases the fight or flight response and/or calms the user by counteracting scariness, etc.) of a user viewing the display to a content of the pixel based on the psychophysiological state assigned to the pixel. That is, the alteration of the environmental characteristic may include an alteration that introduces or increases an environmental condition that contributes to the viewer in the environment experiencing the intended psychophysiological state assigned to the pixel being displayed. Alternatively, the alteration of the environmental characteristic may include an alteration that eliminates or reduced and environmental condition that contributes to the viewer in the environment experiencing the intended psychophysiological state assigned to the pixel being displayed.

Additionally, a psychophysiological response of a display user to viewing the video frame of the video signal may be determined. For example, the psychophysiological responses of the user when viewing the video frames may be monitored or sensed using sensors. In an example, the psychophysiological response of a user viewing a display device may be monitored using sensors positioned in the environment of the display device where the video signal is being viewed.

For example, a plurality of sensors may be present in the environment where the user will be viewing the video signal. In some examples, the sensors may be embedded in the display device and/or in peripherals to the display device. In some examples, the sensors may be sensors present in internet-of-things devices or other computing devices present in the environment. The sensors may determine the psychophysiological response exhibited by a user while they are watching a video frame.

In some examples, an alteration and/or alteration type to be applied to the video signal and/or to an environmental characteristic may be determined and/or applied based on the determined psychophysiological response of a user to viewing the video signal and/or other content associated with a psychophysiological state. For example, the sensors may sense that, when viewing the video signal and/or other content associated with a psychophysiological state, the user exhibits a particular psychophysiological response. For example, the sensors may determine that a user exhibits an elevated heart rate when viewing a video frame of the signal. The video frame of the signal may include pixels that are associated with a violent psychophysiological state. As such, it may be determined that the user's psychophysiological response to viewing pixels associated with a violent psychophysiological state may include an elevated heart rate. The user may have previously expressed that they suffer from a heart condition and that their heart rate should not be elevated. Therefore, an alteration may be applied to avoid the subsequent display of pixels associated with a violent psychophysiological state and/or an indicator thereof. In some examples, a storyline to be presented in subsequent frames of the video signal may be altered and/or supplanted. For example, an alternate storyline for the video signal may be selected and subsequently displayed that contains relatively less or no pixels associated with a violent psychophysiological state.

In some examples, the video signal may include a narrative story. The story may have multiple potential storylines that it may follow. The particular storyline that it follows may be selected and/or modified based on the psychophysiological response of a viewer to the present storyline that is being shown. Since each pixel of each video frame being displayed in the narrative story may be associated with a psychophysiological state, the story line being selected may be selected and/or modified based on the psychophysiological state of its subsequent content.

In some examples, the video signal may be an interactive video signal such as a video game or other interactive presentation. For example, a user may be viewing and/or interacting with video frames of a video game produced by a graphics engine. The video game may also have multiple potential storylines that it may follow. The particular storyline that it follows may be selected and/or modified based on the psychophysiological response of a viewer to the present storyline that is being shown and/or previous psychophysiological responses to previous storylines. Since each pixel of each video frame of the video game being displayed may be associated with a psychophysiological state, the story line being selected may be selected and/or modified based on the psychophysiological state of its subsequent content.

Additionally, an interactive video signal such as a video game or other interactive presentation may include various difficulty settings, levels, graphics settings, video settings, etc. that it may utilize when operating. In some examples, the difficulty settings, levels, graphics settings, video settings, etc. utilized to present the interactive video signal may be altered based on the determined psychophysiological response of the user interacting with the content. For example, if a sensor embedded in a display device or peripheral of a video game system detect that a user is demonstrating a psychophysiological response consistent with boredom, altering the video signal may include increasing the difficulty setting of the video game and/or introducing a new level. In other examples, if a sensor detects that a user is demonstrating a psychophysiological response consistent with frustration, altering the video signal may include decreasing the difficulty setting of the video game and/or changing a level.

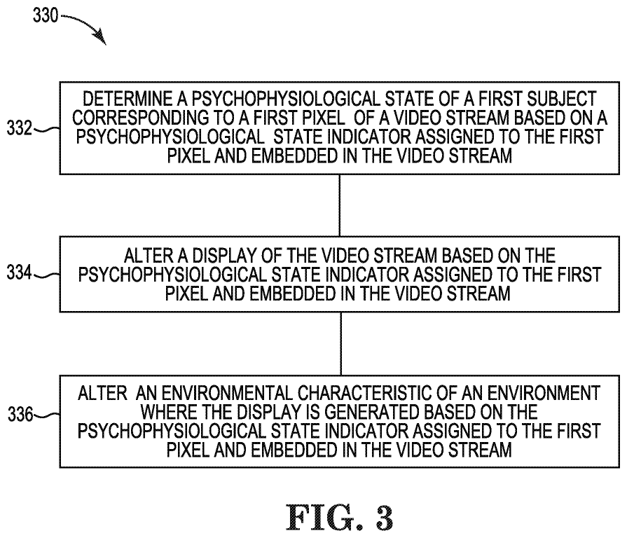

FIG. 3 illustrates an example of a method 330 for utilizing embedded indicators consistent with the present disclosure. The method is not limited to a particular example described herein and may include and/or be interchanged with the described components and/or operations described in relation to FIGS. 1-2 and 4.

At 332, the method 330 may include determining a psychophysiological state of a first subject corresponding to a first pixel of a video stream. The first subject may include a person that will appear in a video frame of a video stream. In some examples, the first subject may be a video game competitor and the video stream may include a live stream of the video game competitor's gameplay and/or a video feed of the video game competitor playing the video game.

The physiological responses of the video game competitor during their video game play may be captured and/or measured utilizing sensors in the environment of the competitor. For example, sensors may be built into a video game monitor and/or a video game peripheral being utilized by the competitor to play the video game. That is, the embedded sensors may capture psychophysiological responses from the competitor while he engages in the game play.

The measured psychophysiological responses of the subjects may be utilized to determine a psychophysiological state of the first subject. The psychophysiological state of the first subject may include a profile of psychophysiological responses matching the psychophysiological responses measured for the subject. The psychophysiological state may include a condition or state of the body or bodily functions of the first subject. The psychophysiological state may include a psychological state, mental state, emotional state, and/or feelings that match the psychophysiological responses measured for the subject.

The psychophysiological responses of the subjects may be analyzed and/or converted to a psychophysiological state indicator value for the subject. The psychophysiological state indicator value may indicate the psychophysiological state of the subject and/or the psychophysiological response data collected from or assigned to the subject.

A psychophysiological state indicator value may be assigned to a pixel of the video stream. For example, the psychophysiological state indicator value for a first subject may be assigned to a first pixel of a video stream that corresponds to the first subject. For example, a pixel that depicts a portion of a first subject and/or is designated to be utilizable to display data for the first subject may be assigned a psychophysiological state indicator value determined for the first subject.

Additionally, a second psychophysiological state indicator value for a second subject to appear in the same frame as the first subject may be assigned to a second pixel of a video stream that corresponds to the second subject. For example, a pixel that depicts a portion of a second subject and/or is designated to be utilizable to display data for the second subject may be assigned a psychophysiological state indicator value determined for the second subject.

The psychophysiological state indicator value for the first subject and assigned to the first pixel and/or the psychophysiological state indicator value for the second subject assigned to the second pixel may be embedded in the video signal communicating the video frame of the two subjects to a display device.

The psychophysiological state of each of the first subject and the second subject may be determined from their respective psychophysiological state indicator values. For example, the psychophysiological state indicator bit value embedded in a video signal and assigned to a pixel may be compared to a look up table to determine the psychophysiological state and/or the psychophysiological state responses corresponding to the psychophysiological state indicator assigned to the pixel. The psychophysiological state and/or the psychophysiological state responses may be attributed to the subject corresponding to the pixel

For example, a psychophysiological state indicator value may be assigned to the first pixel. The first pixel may correspond to the first subject. As such, the psychophysiological state indicator value determined for the first subject may be assigned to the first pixel and embedded in the video signal with the video frame. A display device or intermediate computing device may determine the psychophysiological state associated with the first subject based on the psychophysiological state indicator value assigned to the first pixel corresponding to the first subject. Likewise, a psychophysiological state indicator value may be assigned to the second pixel. The second pixel may correspond to the second subject. As such, the psychophysiological state indicator value determined for the second subject may be assigned to the second pixel and embedded in the video signal with the video frame. A display device or intermediate computing device may determine the psychophysiological state associated with the second subject based on the psychophysiological state indicator value assigned to the second pixel corresponding to the second subject

At 334, the method 330 may include altering a display of the video stream. The alteration to the video stream may be based on the psychophysiological state indicator assigned to a pixel and embedded in the video stream. For example, altering the display of the video stream may include displaying, on a display device, a portion of the measured psychophysiological response of a subject. The portion of the measured psychophysiological response of the subject may be displayed along with the pixel corresponding to the subject of the video stream. For example, the portion of a measured psychophysiological response of the first subject may be superimposed on a portion (e.g., a bottom portion, top portion, banner portion, etc.) of the video frame display while the first pixel corresponding to the first subject is simultaneously displayed on the display device. That is, the first pixel may depict a portion of the first subject and the first pixel may have a psychophysiological state indicator assigned thereto that indicates a psychophysiological state of the first subject. Altering the display of the video stream based on the psychophysiological indicator assigned to the first pixel may include displaying a portion of the psychophysiological responses of the first subject at the first pixel and/or at different pixel in the same video frame.

As described above, the method 330 may include determining a psychophysiological state of a second subject corresponding to a second pixel of the video stream to be displayed simultaneously with the first pixel on a display device. For example, a live video stream may feature two competitors playing against each other. The second subject may include a second competitor in a video game live stream. The psychophysiological response of the second subject may be collected as the second subject competes in the competition.

An indicator of the determined psychophysiological state of the second subject may be assigned to a second pixel corresponding to the second subject and/or where a portion of the second subject is designated to be displayed. Assigning the indicator may include embedding a psychophysiological state indicator value for the second subject in the live video stream. The psychophysiological state indicator value for the second subject may be embedded in the live video stream along with the psychophysiological state indicator value for the first subject assigned to the first pixel. As such, the video signal may include respective psychophysiological state indicators for both of the subjects appearing in the video frame.

Altering the display of the video stream may include displaying information related to the determined psychophysiological state of the first subject, displaying information related to the determined psychophysiological state of the second subject, and/or simultaneously displaying information related to the determined psychophysiological state of the first and second subjects.

In some examples, the method 330 may include switching, based on a user selection of a subject of interest among the first subject and the second subject, between displaying information related to the determined psychophysiological state of the first subject and displaying information related to the determined psychophysiological state of the second subject along with a corresponding pixel depicting a corresponding subject. That is, a user may indicate one of the subjects displayed on a screen that they are interested in. The information related to the determined psychophysiological state of the selected subject may be superimposed over and/or nested within the displayed images of the video signal featuring the subjects.

At 336, the method 330 may include altering an environmental characteristic of an environment where the display is generated. The alteration to the environmental characteristic may be based on the psychophysiological state indicator assigned to the first pixel and embedded in the video stream.

The environment where the display device is located may include smart-home and/or smart-environment devices that may be network connected devices that may be utilized to control environmental characteristics of the environment. The environmental characteristics may include characteristics of the environment such as such as the lighting, humidity, air flow, smell, temperature, sounds, sound volumes, vibrations, orientation of the display, orientation of a user, natural lighting, views, etc.

In some examples, altering the environmental characteristics of the environment where the display is generated may include altering such environmental characteristics based on the determined psychophysiological state assigned a pixel appearing in the video frame. The alteration to the environmental characteristic may be a user-specific and/or user-tailored alteration to an environmental characteristic that will either enhance or counteract the appearance of, communication of, and/or psychophysiological experience elicited by the display of the pixel on the display device.

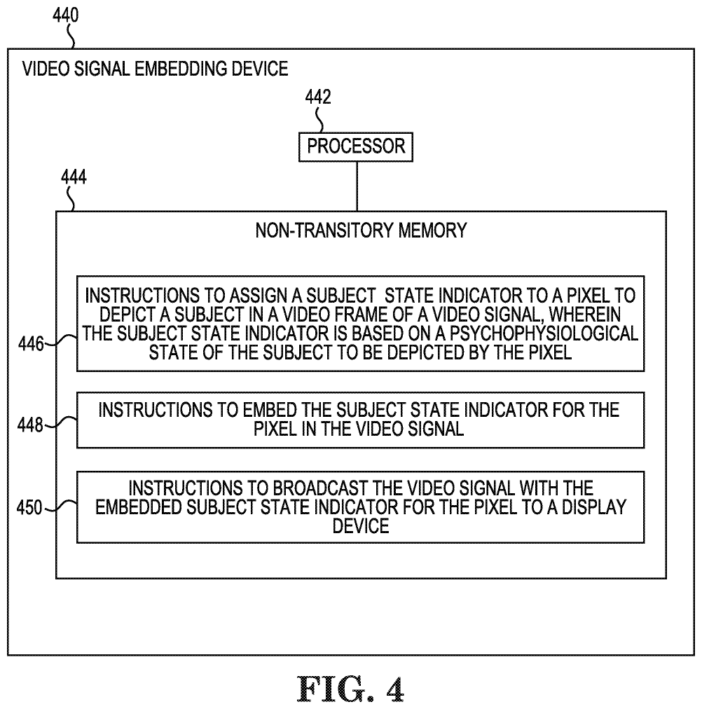

FIG. 4 illustrates an example of a video signal embedding device 440 for utilizing embedded indicators consistent with the present disclosure. The device is not limited to a particular example described herein and may include and/or be interchanged with the described components and/or operations described in relation to FIGS. 1-3.

The video signal embedding device 440 may include a device for generating a video signal for transmission. The video signal device 440 may include a video camera, such as a video camera embedded in a video gaming or streaming setup. In some examples, the video signal embedding device 440 may include a web camera and/or other video encoding hardware.

The video signal embedding device 440 may include a processor 442. The processor 442 may be communicatively coupled to a non-transitory memory 444. The non-transitory memory 444 may store computer-readable instructions (e.g., instructions 446, 448, 450, etc.). The instructions may be executable by the processor 442 to perform corresponding operations at the video signal embedding device 440.

The non-transitory memory 444 may store instructions 446 executable by the processor 442 to assign a subject state indicator to a pixel that is associated with a subject in a video frame. The subject state indicator may be based on and/or indicative of a psychophysiological state of the subject. For example, the video signal embedding device may collect a psychophysiological response of a subject to appear in a video frame. A subject state indicator may be determined for the subject based on the psychophysiological response collected for the subject in the video stream. The subject state indicator may be assigned to a pixel corresponding to the subject whence the psychophysiological response was collected and/or to whom the psychophysiological state is applicable.

The non-transitory memory 444 may store instructions 448 executable by the processor 442 to assign the physiological response to encode captured video frames and subject state indicators assigned to respective pixels of the video frames into a video signal. That is, the subject state indicators and/or a portion of the psychophysiological data of a subject in the video stream may be embedded into the video signal. The embedded subject state indicator and/or psychophysiological response may be embedded in the video signal according to a standardized set of bit values. As such, the embedded subject state indicator and/or psychophysiological response may be embedded in the video signal in a manner that it may be extracted from the video signal by the display and compared to a lookup table to determine the psychophysiological state of the subject. The embedded subject state indicator and/or psychophysiological response may be embedded in the video signal in a manner that allows for it to utilized to perform alterations to the appearance of the video stream on the display device.

The non-transitory memory 444 may store instructions 450 executable by the processor 442 to broadcast the video signal. That is, the video signal embedded with the subject state indicator for the pixel may be transmitted to a device. The embedded subject state indicator may be embedded in the video signal in a manner that it may be extracted from the video signal by the display and compared to a lookup table to determine the psychophysiological response of the subject. The embedded subject state indicator may be embedded in the video signal in a manner that allows for it to utilized to perform alterations to the appearance of the video stream on the display device.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the present disclosure. Further, as used herein, “a plurality of” an element and/or feature can refer to more than one of such elements and/or features.

The figures herein follow a numbering convention in which the first digit corresponds to the drawing figure number and the remaining digits identify an element or component in the drawing. Elements shown in the various figures herein may be capable of being added, exchanged, and/or eliminated so as to provide a number of additional examples of the disclosure. In addition, the proportion and the relative scale of the elements provided in the figures are intended to illustrate the examples of the disclosure and should not be taken in a limiting sense.

What is claimed:

1. A system, comprising:
a processor;
a memory storing machine-readable instructions executable by the processor to:
assign a subject state indicator to a pixel to depict a subject in a video frame of a video signal, wherein the subject state indicator is based on a psychophysiological state of the subject to be depicted by the pixel;
embed the subject state indicator for the pixel in the video signal; and
broadcast the video signal with the embedded subject state indicator for the pixel to a display device.

2. The system of claim 1, including instructions executable by the processor to determine the psychophysiological state of the subject to be depicted in the pixel utilizing a sensor sensing the psychophysiological state of the subject when the video frame is captured.

3. The system of claim 1, including instructions executable by the processor to determine the psychophysiological state of the subject based on a content creator's psychophysiological grading of the subject.

4. The system of claim 1, wherein the embedded subject state indicator for the pixel indicates, to the display device, the pixel among a plurality of pixels of a video frame, to be altered by a psychophysiological state-based alteration operation.

5. A non-transitory machine-readable medium containing instructions executable by a processor to cause the processor to;
determine a psychophysiological state assigned to a pixel in a frame of a video signal based on a corresponding psychophysiological state indicator embedded in the video signal; and
alter a display of the video signal at a display device based on the determined psychophysiological state assigned to the pixel.

6. The non-transitory machine-readable medium of claim 6, including instructions to determine an alteration type to alter the display based on a preference expressed by a user of the display device regarding display of content associated with the psychophysiological state.

7. The non-transitory machine-readable medium of claim 6, including instructions to alter the display of the video signal by visually obscuring a content of the pixel.

8. The non-transitory machine-readable medium of claim 6, including instructions to alter the display of the video signal by displaying a content warning prior to causing a content of the pixel to be displayed.

9. The non-transitory machine-readable medium of claim 6, including instructions to:
determine, from a sensor, a psychophysiological response of a user of the display device to viewing content associated with the psychophysiological state; and
determine an alteration type to alter the display based the determined psychophysiological response of a user of the display device to viewing content associated with the psychophysiological state.

10. The non-transitory machine-readable medium of claim 9, including instructions to alter a storyline to be presented in subsequent frames of the video signal based on the psychophysiological response of a user of the display device to viewing content associated with the psychophysiological state.

11. A method comprising:
determining a psychophysiological state of a first subject corresponding to a first pixel of a video stream based on a psychophysiological state indicator assigned to the first pixel and embedded in the video stream;
altering a display of the video stream based on the psychophysiological state indicator assigned to the first pixel and embedded in the video stream; and
altering an environmental characteristic of an environment where the display is generated based on the psychophysiological state indicator assigned to the first pixel and embedded in the video stream.

12. The method of claim 10, including displaying, on a display device, a portion of a sensed psychophysiological response of the first subject along with the first pixel of the video stream.

13. The method of claim 10, including determining a psychophysiological state of a second subject corresponding to a second pixel of the video stream, to be displayed simultaneously with the first pixel on a display device, based on a psychophysiological state indicator assigned to the second pixel and embedded in the video stream.

14. The method of claim 13, including switching, based on a user selection of a subject of interest among the first subject and the second subject, between displaying information related to the determined psychophysiological state of the first subject and displaying information related to the determined psychophysiological state of the second subject along with a corresponding pixel depicting a corresponding subject.

15. The method of claim 13, including simultaneously displaying, at the display device, information related to the determined psychophysiological state of the first subject and information related to the determined psychophysiological state of the second subject simultaneously with the first pixel and the second pixel.
